(19) United States
(12) Patent Application Publication
(10) Pub. No.: US 2021/0255117 A1
(43) Pub. Date: Aug. 19, 2021

(54) METHODS AND PLANTS FOR LOCATING POINTS ON COMPLEX SURFACES

(71) Applicant: GEICO S.p.A., Cinisello Balsamo (MI) (IT)

(72) Inventors: Paolo COLOMBAROLI, Cinisello Balsamo (MI) (IT); Daniel RASPONE, Cinisello Balsamo (MI) (IT); Bruno DE NISCO, Cinisello Balsamo (MI) (IT); Alessandro DI GIROLAMO, Cinisello Balsamo (MI) (IT)

(21) Appl. No.: 17/251,750

(22) PCT Filed: Jun. 11, 2019
(86) PCT No.: PCT/IB2019/054849

§ 371 Date: Dec. 11, 2020

(30) Foreign Application Priority Data
Jun. 12, 2018 (IT) 102018000006253

(51) Int. Cl. G01N 21/95; G01N 21/88

(52) U.S. Cl. CPC G01N 21/9515; G01N 21/8851; G01N 2021/8861; G01N 2021/9518; G01N 21/8803

(57) ABSTRACT

A method for localizing defects on a complex surface of an object may include: realizing an acquisition assembly with an electromagnetic wave emission device and an optoelectronic device for detecting electromagnetic waves reflected by the complex surface; defining a scan path at a distance from the complex surface; and during a defect search procedure: moving the acquisition assembly along the path; defining instants during the moving of the acquisition assembly at which the acquisition assembly acquires an image of the complex surface as a two-dimensional pixel matrix of the optoelectronic device; storing consecutive two-dimensional pixel matrices obtained along the path; storing coordinates of the acquisition assembly along the scan path and associating the coordinates with respective two-dimensional matrices of the consecutive two-dimensional pixel matrices; locating detects in the consecutive two-dimensional pixel matrices; and/or determining spatial coordinates of the defects detected in the matrix using a linear or linearizable transformation.

The present invention elates to a method and plant for correctly localizing particular points (called here also “significant points”) on a complex spatial surface. The points to be localized may consist in particular of defects in appearance on painted surfaces.

For the sake of simplicity, below the term“significant point” or “defect” will be used without distinction, it being understood however that “defect” also simply indicates a point or zone on the complex surface which differs from the adjacent points or zones in terms of a characteristic parameter thereof (for example contrast, luminosity, colour, etc.) and that this difference is a difference which must be detected and, in some cases, corrected.

For example, defects present on painted surfaces often have a three-dimensional character, i.e. they are not simply local variations in colour, but also consist of reliefs, missing material or in any case irregularities on the surface.

These defects in the jargon of the sector are called “appearance” defects since the user may notice them visually. In general they have dimensions of at least 10-20 microns.

Some spatial surfaces are defined as being “complex” since that may have a combination of concave surfaces and convex surfaces, both also with variable radii of curvature and with the presence of cusps and curvilinear connecting sections between the different parts which form the said surface.

For example, a car body may be regarded as being a complex surface since it has the aforementioned characteristics.

Localizing the defects on a complex surface is a fundamental step of the industrial process, since it allows defects in the appearance of the product, which may be easily noticed by the end user and which are often regarded as being an indication of the quality of the whole product, to be identified and, where necessary, corrected.

According to the present state of the art there exist various methods (both manual and automatic) for detecting appearance defects on complex spatial surfaces as well as methods for spatially localizing specific points, associated with these detect detection methods.

In particular, the defect detection systems which are available on the market are normally based on techniques for detecting the possible presence and the position of the defects by means of optoelectronic devices such as electronic cameras and multidimensional matching and acquisition methods. “Defects” detected on the optoelectronic surface are generally defined as being the position of the pixels or groups of pixels on the photosensitive two-dimensional surface of the acquisition system which differ in terms of contrast and/or luminosity from the other adjacent pixels within given limits and based on a predefined logic.

The most widely used multidimensional matching and acquisition method used is stereoscopic acquisition and matching. For example, acquisition is performed using two cameras which are arranged at a specific distance from each other and the information contained in the images is combined, thus reproducing the behaviour of a human being who uses the visual information obtained by both eyes to determine for example the distance at which an object is situated. The use of a stereoscopic process has drawbacks associated with the relatively complex calculation procedure and possible errors which this produces.

Whatever the acquisition process used, the optoelectronic detection device or devices, depending on the method used for detecting the points on the complex surface, are arranged in defined and known spatial points which are always repeatable over time so that it is really possible to include all the points of the complex surface which is to be checked.

In fact, what happens is that a complex three-dimensional surface which is to be checked for the presence of defects in appearance is projected as a two-dimensional image which is formed on the optoelectronic sensor of the acquisition device or in the memory of the image processing device, as in the case where matrix cameras are used.

The relationship between a complex three-dimensional surface and two-dimensional image is the fruit of a normally non-linear geometric transformation, involving the real points present on the complex spatial surface and their image projected onto the optoelectronic surface used for surface detection.

In the case where stereoscopy methods are used it is therefore necessary to perform calibration of the image points on the target points of the complex spatial surface in order to be able to achieve correctly an optimum association between the real points of the complex surface and their image projected onto light-sensitive surface of the acquisition system. In stereoscopy systems calibration is a complex procedure which poses difficulties in terms of the calculation needed to obtain a satisfactory degree of precision.

For example, with regard to the localization of appearance defects on painted motor-vehicle bodies, it is accepted that the defect to be highlighted, which usually has dimensions of at least 0.01-0.02 mm, may be found within an ideal circle having a radius of less than a few millimetres.

Obviously, it is usually necessary to filter also the optical irregularities and disturbances affecting the surface acquisition process carried out with optoelectronic devices, since these irregularities and disturbances constitute noise which depends on various elements of the acquisition process, but which is not related to the actual presence of any defects. For this purpose, special known algorithms and numerical filters are used, these being applied during processing to the pixels of the photosensitive sensor.

After performing processing in order to detect the position of the pixels on the two-dimensional optoelectronic surface, in order to achieve the actual localization of the defect on the three-dimensional complex surface it is necessary to perform an inverse mathematical transformation and associate in a unique and precise manner the pixel of the optoelectronic device where the defect is present with the spatial point of the complex surface on which the defect is really located (referred to here as defect localization process).

This inverse mathematical transformation may be affected by errors of various kinds; therefore the localization systems attempt to the contain the localization error of the real defect within acceptable limits of the real process.

The localization of the defects detected on a complex spatial surface is a very important activity in an industrial process since, after detecting the defect using any of the known methods, it is also necessary to localize the defect within the space and then signal with a certain degree of precision to the operators along the production line or to the machinery connected downstream the point in space where this defect is present so as to be able to apply the process procedures envisaged in the case where one or more defects are present, depending on their nature. This signalling operation may be performed using different automatic optical signalling systems such as laser pointers, mechanical signalling systems such as delible marking using special paints and pointing with indicators, or computer signalling systems such as displaying of the defects on a high-resolution screen and a database containing the spatial coordinates of the defects and classification of the defects.

As already mentioned above, since an inverse transformation is involved where the pixel in which the defect is detected is associated in a unique manner with the spatial point on the complex surface where the defect is really located, a mathematical error may occur such as not to allow a correct solution of the problem mentioned and result in a quantitatively very large error which cannot be estimated beforehand.

In reality it has been attempted to overcome this problem using different mathematical techniques and methods derived from different technological fields which may be used individually or in combination with each other.

One technique consists in acquiring using the optoelectronic system several optical data relating to the surfaces to be examined, said data differing partially or totally from each other, for example by displacing and suitably rotating within space the photosensitive sensor with respect to the surface.

By suitably directing the photosensitive sensor it is thus possible to simplify the non-linear mathematical transformation to be applied to the complex surface to be examined and the photosensitive two-dimensional surface on which the optical information is formed.

This technique involves for each zone of the surface the examination of a large number of images instead of a single image or a few images.

In particular if the illumination system and the detection system (which may be combined or separate or in any case be synchronized during the image acquisition step) have large dimensions, it will however be difficult to reach the optimum points for acquisition of the complex surface, namely those points where the illumination system must be located in order to illuminate correctly the surface and at the same time those points where the detection system must be located in order to obtain recordings of the complex surface with suitable optoelectronic characteristics (contrast levels, luminosity and correct optical field depth) so as to detect a defect present on the said surface.

In order to increase the capacity to reach a large number of optimum points for optical detection of the complex surface it has been proposed to increase the number of cameras which are independent of each other. This however increases proportionally the complexity of the defect detection system and the associated manufacturing and management costs.

For example, US2013/0057678 describes a system with complex luminous arches which move along a vehicle body while a large number of fixed cameras are directed at each part of the body.

Another technique consists in using only a part of the information recorded so as to simply further the non-linear geometric transformation described above. For example, it is possible to perform a linearization of the transformation within acceptable limits. This technique, however, requires for a complex spatial surface a number of images even greater than that needed for the prior technology, with a consequent further increase in the complexity of the automatic acquisition system and with the need for a consequent increase in the calculation capacity of the processing system located downstream of the detection system.

Another technique consists in increasing the number of image recording cameras which may be located on an automatic programmable positioner or which may be all or partly arranged in fixed positions.

In this way, if there are a sufficient number of cameras and if they are suitably positioned, it is possible to acquire a number of images sufficient to perform correct detection of the defects and a correct inverse transformation so as to associate the optical defects with their real position on the complex surface.

In order to apply this technique, however, a large number of lighting and image acquisition systems are needed and not all of them may be always correctly positioned in the case where complex surfaces with different forms must be examined; this for example occurs if car bodies of different models are analyzed on the same production line.

Another requirement is that of preliminary calibration between the complex surface to be examined and the optoelectronic two-dimensional information, namely defining beforehand the correspondence between the pixel present in the information detected by the optoelectronic sensor and the real point present on the surface.

It is possible to determine this association by means of reference targets suitably arranged beforehand on the sample complex surface. Alternatively, it is possible to establish this association by determining with a high degree of precision the spatial geometries of the complex surface (for example, by means of the information supplied by CAD/CAM systems or similar instruments) and their correct spatial location at the moment when the images of the surfaces are acquired (for example, by means of the data supplied by sensors for detecting the position of the complex surface in three-dimensional space).

This technique, however, results in a significant increase in the information needed for geometric reconstruction of the surface, an increase in the costs for detecting with suitable systems the correct position of the complex spatial surface and, finally, a significant increase in the processing complexity since it is required to store in the processor most of or all the relations and the geometric transformations between the real points where a defect may be potentially located and the pixels of the two-dimensional surface which will be examined when searching for defects.

The object of the present invention is therefore that of providing a method which among other things is able to overcome the aforementioned drawbacks.

In particular, an object is that of providing a method for correctly localizing the points of particular interest on a complex surface, which increases the reliability of the technique and the probability of localizing a point of particular interest, the position of which is not known beforehand.

Another object is that of providing a method for localizing defects in appearance on surfaces, including painted surfaces, which functions with a suitable and generally large number of types of complex surfaces.

Another object is that of providing a method which is simpler than the current methods with a greater degree of freedom of detection of the defects and with a greater possibility of localizing the defects detected.

In view of these objects the idea which has occurred is to provide, according to the invention, a method for localizing defects on a complex surface of an object, comprising the following steps prior to the defect search procedure:
realizing an acquisition assembly with an electromagnetic wave emission device and an optoelectronic device for detecting such electromagnetic waves reflected by the complex surface,
defining a scan path of a significant point of the scanning assembly at a distance from the complex surface;
and during a defect search procedure:
moving the acquisition assembly along the scan path with an automatic positioner:
defining instants “i” during the movement of the acquisition assembly along the path in which the acquisition assembly is operated so as to acquire an image of the complex surface as a two-dimensional pixel matrix of the optoelectronic device;
storing in a control unit the plurality of consecutive two-dimensional pixel matrices obtained at the instants “i” along the path;
storing the coordinates of the acquisition assembly along the path at the same instants “i” and associating them with the respective two-dimensional matrices of the plurality;
identifying defects in the plurality of two-dimensional matrices and identifying for each defect coordinates (Xin. Yin) of the position of the pixels representing the defect in the corresponding two-dimensional matrix, with the index “i” representing the i-th matrix and the index “n” representing the n-th defect detected in the matrix;
locating the spatial coordinates xn, yn, zn on the complex surface of the barycentre of the defect n detected in the i-th matrix by means of a linear or linearizable transformation applied to the coordinates Xin, Yin of the n-th defect detected in the i-th matrix.

Still in accordance with the principles of the present invention the idea which has also occurred is that of providing a plant adapted to operate according to the preceding method, comprising a station for detecting the defects on the complex surface of an object arriving at the station, in the station there being present the programmable positioner, the acquisition assembly with the device for emission of electromagnetic waves and the optoelectronic device for detecting such electromagnetic waves reflected by the complex surface, said acquisition assembly being mounted on the programmable positioner so as to be movable along paths on the complex surface of the object.

The device for localization of the defect on the three-dimensional surface may be mounted on the aforementioned programmable positioner or on a different programmable positioner present in a following station.

In order to illustrate more clearly the innovative principles of the present invention and its advantages compared to the prior art, an example of embodiment applying these principles will be described below with the aid of the accompanying drawings. In the drawings:

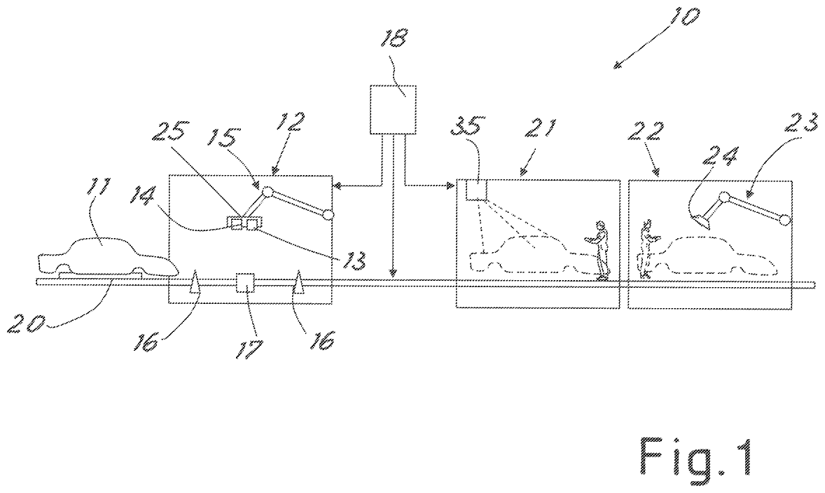

FIG. 1 shows a schematic view of a plant provided according to the invention;

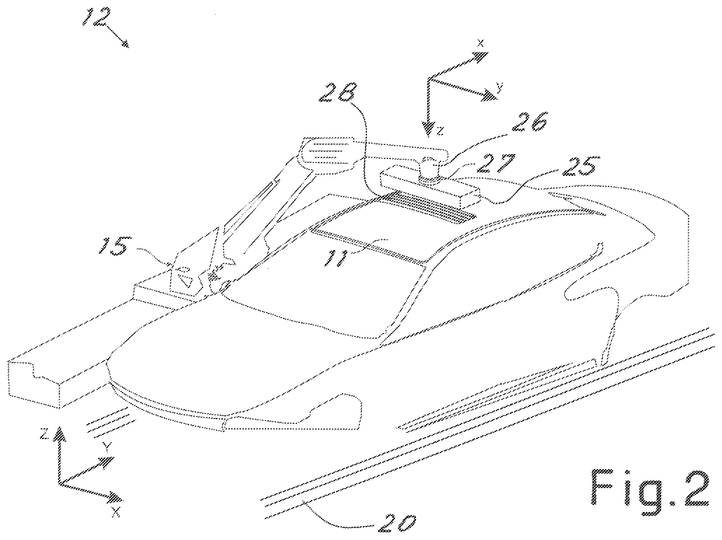

FIG. 2 shows a schematic view of a station in the plant for detecting defects;

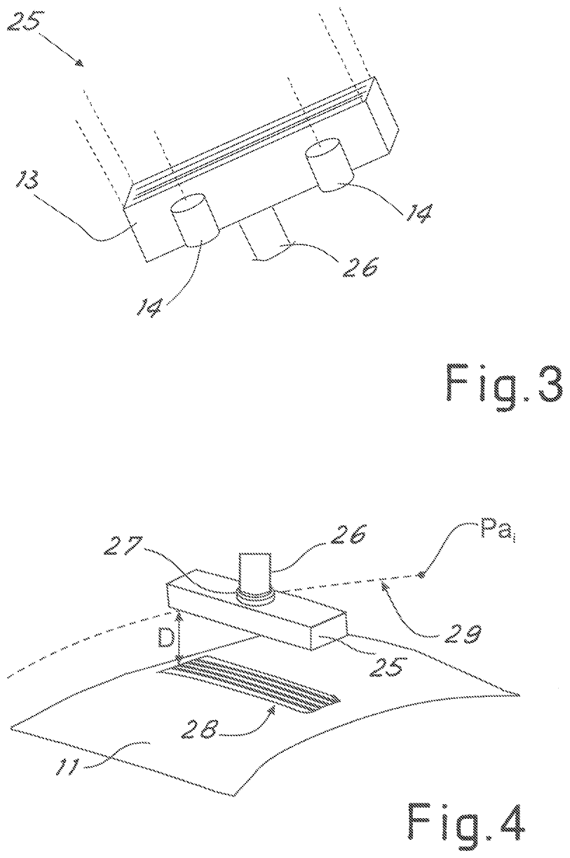

FIG. 3 shows a schematic view of a possible embodiment of an acquisition assembly for detecting defects according to the invention;

FIG. 4 shows schematic view of a possible movement of an acquisition assembly according to the invention;

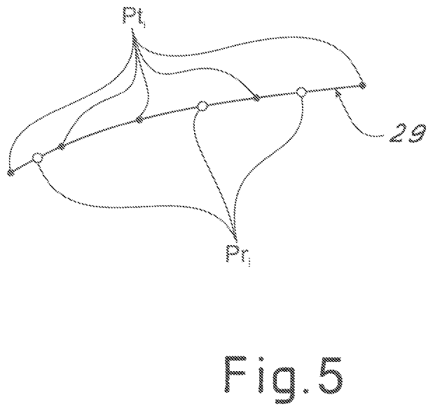

FIG. 5 shows a schematic view of the composition of a path for the movement of an acquisition assembly according to the invention;

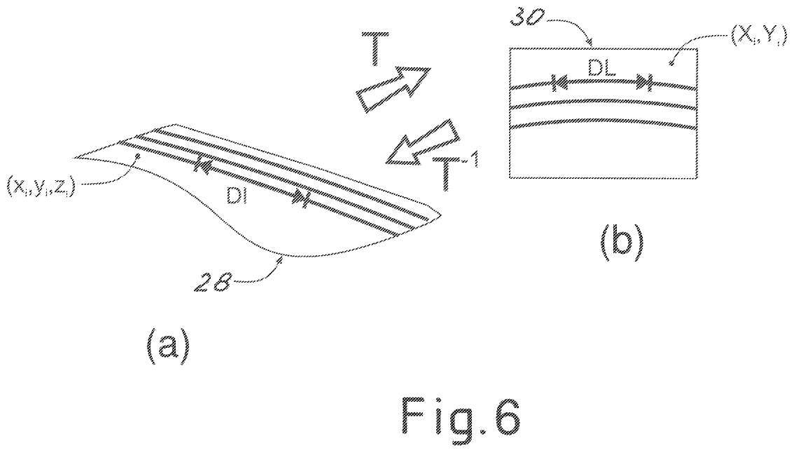

FIG. 6 shows a schematic view of the transformation between points on a complex surface and a two-dimensional surface of an optoelectronic device of the acquisition assembly according to the invention; and

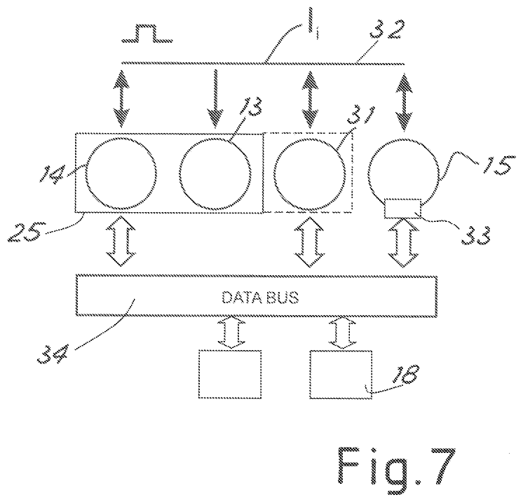

FIG. 7 shows a possible connection diagram of components forming the plant according to the invention.

With reference to the Figures, FIG. 1 shows a plant 10 provided according to the invention for detecting defects on an object 11, for example the painted body of a motor vehicle.

The plant comprises at least one station 12 for detecting the defects. Advantageously, the plant 10 may also comprise a known transportation system 20 which carries in sequence objects 11 into the station and removes them from the station after the operations for detecting any faults. The transportation system may be for example a conveyor. In the case where the objects 11 are vehicle bodies, the bodies may also be mounted on skids and the conveyor 20 may be a known skid conveyor.

A station 21 for classifying defects and a station 22 for removing the defects may be advantageously present downstream of the station 12. In the station 21 an operator may examine visually the defects which will have been detected automatically in the station 12 and decide if necessary whether they are of such a size that they must be removed and/or if they can be really removed using the removal procedures associated with the station 22.

In order to indicate to the operator in the station 21 the position on the surface of the body of the defects detected in the station 12 (the aforementioned step is called the “defect localization step”), the device 21 will comprise indicator devices 35. These devices receive the coordinates of the defects which have been detected in the station 12 and indicate on the surface of the object 12 the positions in which the defects are present.

For example, the devices 35 may comprise visible light beam projectors known per se (for example laser projectors) which can be controlled so as to direct the beams towards the spatial points in the station 21 depending on spatial coordinates which are sent from the unit 18 to the projectors.

In this way, the unit 18 may control operation of the projectors, suitably arranged around the object 11 arriving in the station 21, so as to illuminate the points on the surface of the object where the defects are present. Illumination of the defect may be performed for example by means of an illuminated zone (for example a circular light spot), the spot containing inside it the defect or also encircling the defect with an illuminated perimeter (for example a circular edge).

Alternatively, the indicator devices 35 may comprise enhanced reality devices such as enhanced reality glasses, which are worn by the operators and which receive the spatial coordinates of the defects and which show areas for highlighting the defects which are superimposed on the direct vision of the object by means of the glasses, or also portable tablet computers for simplifying the search procedures and categorizing the defect which by means of a reconstruction of the scanned area identify on the screen the position of the defects.

Alternatively, the indicator devices 35 may comprise a system for delibly marking the defect on the car body such as markers which are suitably mounted on automatic devices such as 23 (for example by means of one or more robotic arms such as 23 with a suitable number of degrees of freedom for being able to reach and operate with markers on the defects detected on the object 11).

In any case, the operator will have a precise indication of the defects detected by the station 12 and may decide for each defect whether it may be removed in the station 22, whether it may be ignored or whether it is necessary to discard the object, along with the need for any further machining operations which are not possible in the station 22 (for example need to repaint the object).

The operation of removing the defects may be performed manually by an operator who is suitably equipped (for example with an electric sanding/polishing tool) or may be automated with automatic devices 23 (for example by means of one or more robotic arms 23 having a suitable number of degrees of freedom so as to be able to reach and operate with their automatic tools 24 on the defects detected on the object 11).

In the case of manual operation, the station 22 may comprise indicator devices, similar to those of the station 21, for indicating to the operators responsible for performing the removal operation the position on the body of the defects which are still indicated as such after the selection performed in the station 21.

In the case of automated operation, the devices 23 will receive the spatial coordinates of the defects which are indicated as still being such after the selection performed in the station 21 and which are to be removed from the surface of the object and will operate on these defects using their appropriate tools 24.

If necessary, the stations 21 and 22 may be combined in a single inspection and removal station or one of the two stations may be totally dispensed with if considered unnecessary.

For example, it may be envisaged that the same operators who inspect the defects as described above with reference to the station 21 operate directly on the defects so as to remove them as soon as they have been localized, avoiding the transfer to the station 22.

Removal operations comprising two or more steps, depending on the size and nature of the defect, using several removal stations may also be envisaged.

Furthermore, in the case where the step of selection of the defects by an operator is not required, the station 21 may be dispensed with and the removal station directly accessed. For example, in the case of automatic removal, it is possible to imagine using directly only the station 22 with the automatic devices.

In order to detect the defects, the station 12 advantageously comprises an electromagnetic wave emission device 13 and an optoelectronic device 14 for detection of the electromagnetic waves reflected by the object 11.

The device 14 may also be formed by several optoelectronic devices or optical sensors which are suitably linked together, for example several cameras, as will be explained below.

The electromagnetic waves must be chosen so as to be suitable both for being reflected by the surface of the object 11 on which the defects are to be identified and for being correctly detected by the optoelectronic device 14 after reflection.

In particular, the emission device 13 may be a wide-spectrum illumination device either with a small bandwidth or with a single wavelength, depending on the needs and preferences.

The electromagnetic wave may be within the range of electromagnetic radiation which is visible to the human eye or invisible (for example, infrared radiation). The optoelectronic device 14 will be chosen so as to be sensitive at least to a part of the band emitted by the source.

Such an optoelectronic device 14 may comprise for example one or more conventional CMOS technology cameras which are also sensitive to near-infrared radiation or in any case to the wavelengths of the light emitted by the illumination device 13.

Advantageously, the emission device 13 and the optoelectronic device 14 are arranged close together and are combined to form an acquisition assembly 25.

Preferably, the emission device 13 and the optoelectronic device 14 may be arranged in the acquisition assembly 25 substantially in alignment with each other close together so that the electromagnetic radiation reflected and diffused by the object 11 in all the directions may allow superficial appearance defects and painting defects to be detected with a better signal-noise ratio and therefore with a better probability of detecting correctly the defect.

As can be seen again in FIG. 1, the station 12 also comprises an automatic programmable positioner 15 on which the acquisition assembly 25 is mounted and which allows, using the methods described below, travel along paths suitable for short-distance scanning of the three-dimensional complex surface of the object on which the defects are to be detected.

In particular, the positioner 15 may advantageously be a robot with six axes controllable in an interpolated manner or an anthropomorphic robot, with the acquisition assembly mounted on the robot's wrist.

The station 12 (and where applicable also the stations 21,22) will preferably comprise a position system known per se which will enable the position of the object 11 inside the station to be established with the desired degree of precision. This position system may comprise physical positioning locators 16 and/or position detection sensors 17. For example, the physical locators may be suitable mechanical stops for stopping the object inside the station and/or locating pins which, when the object reaches the station, are inserted precisely inside corresponding holes in the object or in a support joined together with the object and moved with it.

The sensors may be for example optical and/or electromechanical position sensors, as may be easily imagined by the person skilled in the art. The position detection sensors may also be assisted by reference targets which are placed on the surface of the object, as may be easily imagined by the person skilled in the art. The actual transportation system may be designed so as to cause the object 11 to stop in a precise position inside the station.

In any case, the object 11 will be arranged in the stations in a precise position or in any case in a known position and the spatial coordinates which are detected on the surface of the object will all refer to this position, such that a set of spatial coordinates of a point on the surface of the object within a station will correspond to (or in any case may be easily converted so as to correspond to) the spatial coordinates of the same point in the other stations.

The plant 10 will also comprise an electronic control unit 18 (advantageously one or more suitably programmed electronic processors) which, using the methods will be explained below, will control operation of the programmable positioner and the acquisition assembly and will receive any signals from the object position system. This unit 18 may also be formed in practice by several control sub-units (each assigned to one of the functions required for operation of the plant, such as control of the single robot, the single defect acquisition and identification system, the single defect signalling and/or removal system, etc.) which are suitably interconnected so as to exchange the necessary data, as will be clarified below.

FIG. 2 shows in schematic form and in greater detail a possible embodiment of the station 12.

As can be seen in this figure, the automatic programmable positioner 15 is preferably formed by a robot with seven axes controllable in an interpolated manner (anthropomorphic robot) having a wrist 26 with an engaging flange 27 on which the acquisition assembly 25 is mounted.

The three-dimensional complex surface of the object 11 on which the defects are to be detected forms for example part of a motor vehicle body brought into the station by the sequential transportation device 20.

As can be clearly seen in FIG. 2, the acquisition assembly 25 is preferably made with an elongated form along an axis (Y-axis in FIG. 2) which will be transverse to the movement path of the acquisition assembly 25, such as to cover a correspondingly elongated (advantageously rectangular) zone 28 on the complex surface of the object where the radiation beam generated by the emission device 13 is projected.

For example, the acquisition assembly may cover a zone with a breadth of a few millimetres (for example, 5 to 30 mm) in the direction of movement along the path and a width of for example a few tens of centimetres (for example, 25 cm to 1 m) in the transverse direction. In general, the dimensions of the area covered will be in the ratio of at least 1:10 for the dimension along the path and the dimension transverse to the path.

Owing to the small breadth in the direction of movement along the path, the transformation between image detected and portion of the scanned surface may be regarded as being substantially linear or in any case linearizable with a sufficiently small error, as will be explained below.

FIG. 3 shows in schematic form a possible embodiment of the acquisition assembly 25 viewed from the side where the electromagnetic beam is emitted. This assembly 25 comprises the emission device 13 formed by a rectangular elongated illuminator for illuminating the said rectangular zone and a pair of cameras which form the optoelectronic device 14 for detecting the electromagnetic waves reflected by the object 11. The cameras 14 are fixed to the illuminator, being arranged on the side thereof and spaced along its axis in order to detect correctly the entire rectangular zone lit up by the illuminator on the complex surface.

In any case, advantageously, after mechanically fixing the emission device 13 onto the programmable positioner, such as the wrist of the anthropomorphic robot, so that it projects an electromagnetic radiation beam onto at least a part of the complex surface to be inspected, the optoelectronic device is mechanically fixed to the terminal zone of the automatic programmable positioner so as to receive correctly the electromagnetic radiation beam reflected by the surface to be inspected.

As can be seen in FIGS. 2 and 3, the illuminator is preferably designed to project a rectangular image formed by thin, alternating, light and dark, parallel bands extending along the greater axis of the rectangular image. These bands will extend transversely with respect to the movement path of the acquisition device along the complex surface. This may improve the detection of the defects. In any case a uniformly lit zone may also be used.

FIG. 4 shows in schematic form the acquisition assembly 25 which projects the image into the zone 28 while it is moved (by means of the positioner 15) at the distance D along a path 29 above the complex surface of the object 11 (for example the roof of a body).

Since the extension of the acquisition assembly 25 will generally be rectilinear and flat, while the complex surface will generally have a non-planar extension, the known distance of at least one predetermined point of the acquisition assembly from the complex surface to be examined may be regarded as being the distance D. The path 29 may be for example that followed within the space by this predetermined point.

The distance D may depend for example on the type of surface and the type of defect searched for. In general, a distance D found to be advantageous may be between 5 and 50 cm.

As schematically shown in FIG. 5, the continuous path 29 may be defined in the space by a discrete set of points Pt (where “t” indicates that they are points necessary for defining a path and “i” indicates the i-th point necessary for defining the said path), said points being identified and saved preferably during a setting step which precedes scanning of the surface by the acquisition assembly for the defect search.

A suitable algorithm known per se may calculate the entire path from this discrete set of points of Ptᵢ, as may be easily imagined by the person skilled in the art. Along the path 29 it is possible also to identify positions Prᵢ (where “r” indicates that they are detection positions of the surface along the various paths and “i” indicates the “i-th” detection position along the said path), these positions being in addition to the points Ptᵢ which define the path, where detection of the defect images is performed, as will be explained below.

The projection of the electromagnetic radiation and the consequent detection thereof by the optoelectronic device, after reflection by the complex surface of the object 11, must be performed correctly along the entire defect detection path. Along the path it is therefore necessary to ensure also the correct inclination of the acquisition assembly with respect to the surface, namely correct relative positioning of the emission device 13 and detection device 14. In other words, for correct acquisition of the defects on the complex surface, the position of the acquisition assembly must be defined in a sufficiently complete manner in the space along the chosen paths.

In any case, once the path has been defined, it will be sent to the positioner 15 for execution within the space, the acquisition assembly being moved along this path. As will be further explained below, during the defect search procedure, the acquisition assembly, during the movement along the path, will acquire images of the complex surface at predefined instants, and the positions of the device along the path at those instants will be associated with these images. A suitable linear or linearizable transformation will allow the subsequent conversion into the spatial coordinates of the points on the complex surface based on the coordinates of the two-dimensional image recorded in the specific position along the path. In this way, once the position of a defect in the two-dimensional image recorded has been identified, the precise spatial position of the defect on the real complex surface will be obtained.

FIG. 6 shows in schematic form the correspondence between points of interest in the zone 28 of the complex surface scanned (FIG. 6a) and their representation on a two-dimensional sensitive surface 30 of the optoelectronic device 14 (FIG. 6b) which in general will correspond to a two-dimensional pixel matrix. A generic segment DI on the complex surface, measured in mm, corresponds to a segment DL on the two-dimensional surface 30 of the device 13, measured in pixels.

Xᵢ, Yᵢ define the two-dimensional coordinates of any i-th point of the two-dimensional surface 30 of the optoelectronic device, while the coordinates xᵢ, yᵢ, zᵢ define the spatial coordinates of any i-th point of the complex surface 28 of the object 11.

It is therefore required to find the transform T (and the corresponding inverse transform T⁻¹) which allow the conversion from xᵢ, yᵢ, zᵢ to Xᵢ, Yᵢ and vice versa for all the points of the complex surface which contain a defect.

Advantageously, for correct localization of the points of particular interest (referred to in the present description for sake of simplicity as “defects”) which may be present on the complex surface of the object, an initial system set-up procedure may be useful in order to ensure that the acquisition assembly is ready to operate correctly following suitable paths 29, finding suitable coefficients of the transform which will be used during localization of the defects, as will be explained below.

In order to obtain the appropriate coefficients the initial procedure described below may be advantageously adopted.

The initial system set-up procedure may envisage providing at least one point of the sensitive surface of the optoelectronic device, which is fixed to the end zone of the automatic programmable positioner, at a known distance from the complex surface to be examined, which will remain approximately constant for each surface scanning operation (for example the aforementioned distance D), and then directing the acquisition assembly (or the optoelectronic device, if separate) with a suitable angle relative to the complex surface so that all the points of interest of the zone of the scanned surface are projected onto a zone of the sensitive two-dimensional surface 30 of the optoelectronic device 14.

Advantageously, preferably the projection gives rise to a correspondence between the points of interest in the zone of the scanned surface and the points in the confined zone of the sensitive two-dimensional surface of the optoelectronic sensor which is advantageously a mathematical transform T which is linear and, if not linear, at least linearizable.

Once the correct position has been obtained, the absolute position in the three-dimensional space of the end zone of the automatic programmable positioner (namely the position reached by the positioner with the acquisition assembly) is recorded in a memory of the electronic control unit 18 as point Ptᵢ.

This position may for example be in relation to the flange centre of the anthropomorphic robot's wrist.

The positioner is then moved so as to scan a different zone of interest on the surface of the object and the aforementioned operations are repeated, and so on, until the whole of the complex surface has been scanned at suitable intervals so as to allow transformation of the all the points on the complex surface into points (pixels) on the two-dimensional surface 30 of the optoelectronic device 14.

At the end of the process, the aforementioned memory of the electronic control unit 18 will contain all the absolute positions Pt assumed during scanning by the automatic programmable positioner. It should be noted that the number “n” of positions saved may also be less than the number “m” of positions which is required in order to perform complete point-to-point scanning of the complex surface to be examined. In other words, n≤m.

During the initial procedure, markers which can be easily identified by the acquisition system (for example, coloured stickers) will be suitably placed on the complex surface of a sample object (generally similar to or the same as the objects which will be subsequently analyzed in the station), these stickers being arranged in pairs at a suitable distance DI from each other so as to be visible along the path. This is shown in schematic form again in FIG. 6 where DI represents a segment on the complex surface 28 between two points on this complex surface. The points on the complex surface arranged at the distance DI, which may be measured in mm, will be detected by the acquisition device as points at a distance DL, which can be measured in pixels, on the two-dimensional surface 30 of the device 13. DL (Xᵢ−Xᵢ₋₁, Yᵢ−Yᵢ₋₁) is therefore the segment on the two-dimensional surface 30 corresponding to the segment DI (xᵢ−xᵢ₋₁, yᵢ−yᵢ₋₁, zᵢ−zᵢ₋₁.) of the complex surface 28.

The transformation between a point on the two-dimensional surface 30, which for example may be related to the origin of the sensitive surface (Xᵢ₋₁=0, Yᵢ₋₁=0), and the corresponding segment with both the points of the complex surface 28, which may be both related to the origin of the coordinates of the positioner (x=0, y=0, z=0), may therefore use a conversion multiplication coefficient, called expansion coefficient, which can be applied to the inverse transform, expressed for example in mm/pixel, of the n-th zone present in the i-th detection:

Cₙᵢ=DIₙᵢ/DLₙᵢ

If possible, a small number of conversion coefficients Cₙᵢ will be chosen and may also be approximated to one only for each single i-th detection of the complex surface, called Cᵢ, and the conversion coefficient may also be approximated again to the same value, called C, for the different parts of the complex surface acquired with the optoelectronic device.

By means of a suitable path tracing algorithm (per se substantially known and therefore not further described or shown here) it is possible to connect logically together the saved points Ptᵢ so as to form a continuous path which passes through these points and which is the path 29 useful for performing a complete scan of the complex surface by means of the optoelectronic device 14 moved by the positioner. Further points (as for example shown in FIG. 4), which define further positions Pa of the automatic programmable positioner, may also be added to the path 29 thus formed. These positions Paᵢ (where “a” indicates that they are accessory points necessary for connecting together the different paths and “i” indicates the i-th point necessary for connecting the said path) are not necessary for scanning of the complex surface, but are close to the positions Ptᵢ and will act as positions connecting together, along the whole path, different segments of the path formed by the saved scanning positions, so as to define a single path which the automatic programmable positioner may travel along from an initial point to an end point in the scanning operation.

Once the initial procedure of definition of the path of the programmable positioner has been completed, it is possible to scan fully the complex surface for an automatic defect search.

During this search, the positioner follows the set path 29 so as to scan fully the complex surface at a speed V (which may be for example set on the controller of the automatic positioner). This speed V may also be constant and be included between a minimum speed Vₘᵢₙ and a maximum speed Vₘₐₓ, where the speed range varies from 100 mm/s to 1000 mm/s. The speed V will also depend on the actual hardware and software characteristics of the devices used in the method described, which may reduce or increase the speed of correct scanning of the complex surface.

As mentioned above, the detection positions Prᵢ along the path, where detection of the points on the complex surface is performed, may be different, in terms of absolute position and number, from the positions which were saved in the memory during the path definition step. In any case, the number of positions Prᵢ along the path where the detection of the points of the complex surface is performed must be sufficient to perform a full scan of the complex surface. Essentially, the positioner moves the acquisition assembly along the path and, at predefined time intervals, the acquisition of the image of the surface zone being scanned at that moment is performed.

The formula Tᵢ≤Lᵢ/Vᵢ may be used to establish at least the positions Prᵢ of the automatic programmable positioner where the detection of the points of the complex surface must be performed by means of the optoelectronic device 14 mounted on the automatic positioner 15 which travels along a path segment at a speed Vᵢ which is also constant along each path segment 29. In this formula, Tᵢ is the time interval between a scan in a position Prᵢ₋₁ and a subsequent scan in the position Prᵢ; Lᵢ is the length of the area 28 in the direction of movement of the complex surface recorded by the optoelectronic device (i.e. for example the transverse distance between the first and the last dark electromagnetic band projected onto the complex surface), said area 28 being projected onto the two-dimensional surface 30 of the optoelectronic scanning device; Vᵢ is the speed, sometimes constant, at which the automatic positioner moves along the path.

In other words, between one detection operation in the position Prᵢ₋₁ of a zone of the complex surface and the next detection Prᵢ of another zone a time period less than Tᵢ (oversampling of the surface) or at the most equal to Tᵢ (sampling of the surface without superimposition of images) must lapse in order to scan completely, one zone at a time, each point on the whole complex surface.

The acquisitions may therefore be performed at instants Tᵢ where |Tᵢ₊₁−Tᵢ|≤Lᵢ/Vᵢ, and “i” indicates the i-th acquisition.

For example, it is possible to generate a pulse Iᵢ, i.e. detection or trigger pulse, (where “i” indicates the i-th pulse) in order to command the optoelectronic device for detection of the complex surface at the instants T.

If it considered necessary, a similar pulse, or the same pulse, may also be used to activate the device for electromagnetic emission towards the complex surface, when it must be activated, not continuously during scanning, but on the contrary used to perform an instantaneous electromagnetic emission of short duration (called “strobe”).

The detection pulse Iᵢ may be emitted by the control unit 18 or ay also be obtained by means of a pulse generator which is separate from the control unit and which may emit this pulse at time intervals which may also be very short. The generator device may also be included in the acquisition assembly.

The same procedure for defining the acquisition instants may be used during the initial set-up step already described above for detection of the images useful for calculation of the coefficients Cᵢₙ.

FIG. 7 shows in schematic form a possible diagram for connecting the system also to a pulse generator 31 where provided.

The pulses may be sent to the acquisition assembly via a connection 32 which may be a simple electrical connection which transmits the electric pulse directly or a data processing network which transmits the electric pulse in the form of a command with a suitable coding, as may be now easily imagined by the person skilled in the art.

The acquisition assembly 25, the generator 31 (where present) and the positioner 15 (which may be combined with an associated low-level control unit 33) may also be connected to the control unit 18 via a known data bus 34.

Upon each i-th acquisition at the instant Tᵢ (namely at each i-th trigger pulse Tᵢ (if present) the absolute position Prᵢ of the automatic programmable positioner and the elements of the pixel matrix 30 of the optoelectronic device, which were obtained in that position by means of the acquisition of a part of the complex surface, are saved in the control unit 18 (and/or in another processing device of the plant).

The pixels of the matrix 30 may be processed so as to create an association between the absolute position Prᵢ of the automatic programmable positioner and the pixel matrix for each i-th acquisition.

The processing of this information may also be performed in the same control unit of the automatic positioner or in another processing device (for example a suitable appropriately programmed processor).

The processing of the pixels in order to identify the defect may be performed during scanning, at the end of scanning, or partly during scanning and partly at the end of scanning, depending on the specific preferences and practical requirements and the power of the processing system used.

For each i-ith acquisition performed with the optoelectronic device 14 it is possible to identify those pixels in the image of the two-dimensional surface 30 where there are “significant points” (for example defects in appearance, but also other types of defect as well), namely those points which differ, in terms of values of predetermined parameters (for example luminosity and/or contrast and/or colour, etc.), from adjacent points in the image and which must be detected in the image in order to be then spatially localized on the real complex surface.

The position of the pixels representing the significant points in the two-dimensional pixel matrix 30 obtained with the optoelectronic device may be represented by means of the coordinates (Xᵢₙ, Yᵢₙ) of the pixel matrix of the surface 30 of the optoelectronic device, with the index “i” which represents the i-th scanning and the index “n” which represents the n-th significant point detected in the matrix.

Advantageously, in the case where the significant point corresponds to a group of adjacent pixels, instead of a single pixel or point, the position of the significant point in the two-dimensional matrix 30 may be defined with the coordinates of the barycentre of the group of points, namely (X_{inb}, Y_{inb}) (where “b” indicates the barycentre) approximated to the closest coordinate.

For the sake of simplicity below the position of the significant point in the two-dimensional matrix 30 will be indicated always with (Xᵢₙ, Yᵢₙ), also in the case of the coordinates (X_{inb}, Y_{inb}) of the barycentre of a significant point.

Once the coordinates (Xᵢₙ, Yᵢₙ) of the significant point in the two-dimensional image have been obtained, it is necessary to localize this significant point on the complex surface, namely it is necessary to determine the spatial coordinates (xₙ, yₙ, zₙ) of the point on the complex surface.

In order to achieve this, it is advantageously possible to implement the following procedure performed by the electronic control unit of the system.

Firstly, the index of two-dimensional matrix 30 of the optoelectronic device containing the significant point to be transformed is determined, for example if the significant point was acquired at the instant “Ti” with the i-th trigger it is necessary to consider the index “i”.

Then the absolute i-th position of the automatic programmable positioner, associated with the i-th instant (namely the position of the acquisition assembly moved by the positioner at the i-th instant), is determined.

For example, there will be the parameters (xᵣᵢ, yᵣᵢ, zᵣᵢ, rxᵣᵢ, ryᵣᵢ, rzᵣᵢ) where “r” indicates the coordinate of the flange centre of the wrist 26 of the robot 15 shown in FIG. 2 and where indicates the i-th trigger instant. As is known to the person skilled in the art, x, y, z indicate the spatial coordinates of the end of the positioner and rz, ry, rz indicate the angles of rotation of this end with respect to the three axes, such that the position and direction of the positioner (and consequently the acquisition assembly moved by it) are fully defined.

With regard to the explanation above, the absolute i-th position of the automatic programmable positioner is also associated with the i-th two-dimensional matrix of the optoelectronic device.

This is followed by determination of the correction to be performed during the search for the significant point on the complex surface using the coordinates (Xᵢₙ, Yᵢₙ) in the two-dimensional matrix of the significant point transformed and present in the i-th detection. This correction is performed by applying one or more suitable calibration coefficients Cᵢₙ which were obtained during the initial calibration, as already mentioned above, taking two suitable points on the complex surface, tracing these two points at the instant Ti in the matrix 30 of the image recorded by the acquisition assembly and measuring the distance DIᵢ (for example expressed in mm) between the two points on the complex surface and the distance DLᵢ (for example expressed in pixels) between the same two points transformed into the pixels of the two-dimensional surface 30 of the optoelectronic device (FIG. 6).

The absolute position of the end of the automatic programmable positioner with respect to the significant point of the complex surface is localized by adding together the absolute position Pᵢ assumed by the automatic programmable positioner at the moment of the i-th trigger and the spatial coordinates obtained with the inverse transform T⁻¹ of the coordinates of the pixel of the significant point Pin present in the pixel matrix 30 of the optoelectronic device at the moment of the said i-th trigger.

For example, if X defines the axis of the two-dimensional pixel matrix followed by the path for scanning of the complex surface and Y defines the axis transverse to the scanning direction, the coordinates (xₙ, yₙ, zₙ) of the significant point n during the i-th scan in the space will be equal to:

xₙ=xᵣᵢ+cᵢₙ*(a₁₁*Xᵢₙ+a₁₂*Yᵢₙ)

yₙ=yᵣᵢ+cᵢₙ*(a₂₁*Xᵢₙ+a₂₂+Yᵢₙ)

zₙ=zᵣᵢ+cᵢₙ*(a₃₁*Xᵢₙ+a₃₂*Yᵢₙ) (1)

where the coefficients aᵢⱼ, which may also have a negative sign and which are determined in each case for each inverse transform, depend on the relative position of the complex surface in the space and locally on the direction followed by the surface in the space and may be calculated as simple trigonometric transformations, which may be now easily imagined by the person skilled in the art and therefore will not be further described or shown here.

By way of example, considering a point Pn with coordinates (xₚₙ, yₚₙ, zₚₙ) on the complex surface, recorded as the point Px (with coordinates Xᵢ, Yᵢ) in the i-th image recorded at the point Pri with coordinates (xri, yri, zn) along the path at the distance D (parallel to the axis Z) from the complex surface, the following simple transformation relation will be obtained (as will be clear to the person skilled in the art):

xₚₙ=xᵣᵢ+cᵢₙ*(Xin cos α−Yin senα)

yₚₙ=yᵣᵢ+cᵢₙ*(Xin senα+Yin cos α)

zₚₙ=zᵣᵢ−D

where α=angle of inclination of the absolute axes X, y to which the complex surface is related, relative to the axis X, Y of the optoelectronic device.

The desired spatial coordinates of the defect on the complex surface is thus obtained.

Advantageously, the aforementioned calculations may be further simplified using the so-called operation mode of the automatic programmable positioner which is called the “tool” function and which exists in many anthropomorphic robots.

To use this function, the absolute position of the automatic programmable positioner is localized with respect to the significant point of the surface by working in the so-called tool function operation mode of the automatic programmable positioner, suitably defining the reference axes as “z tool”, “x tool” and “y tool” axes.

In particular it is possible to define during the initial set-up step a “z tool” axis as the direction of movement of the flange 27 of the robot's wrist along the perpendicular to the said flange, with a positive sign indicating a movement towards the surface; an “x tool” axis as the direction of movement of the flange in the direction of travel along the path, with a positive sign indicating that scanning is proceeding along the path; a “y tool” axis as the direction orthogonal to the direction of travel along the path and orthogonal to the direction of movement of the flange along the perpendicular to the said flange, with a positive sign corresponding to the left-hand screw thread rule. By positioning the automatic programmable positioner in the absolute position assumed by the automatic programmable positioner at the moment of the i-th trigger and using the tool function mode, the spatial position of the flange centre of the robot is corrected by means of the inverse transform of the pixel coordinates of the significant point “n” present in the optoelectronic matrix at the moment of the said i-th trigger, where the axis X of the surface of the optoelectronic sensor is aligned with the “x tool” axis of the automatic positioner in the same direction and where the axis Y of the surface of the optoelectronic sensor is aligned with the “y tool” axis of the automatic positioner in the same direction.

Therefore, the corrections “delta x in tool mode” and “delta y in tool mode” for the n-th significant point determined in the i-th detection are equal to:

Dₓᵢₙₜₒₒₗ=cᵢₙ*Xᵢₙ

D_{yintool}=cᵢₙ*Yᵢₙ

In order to localize using the absolute coordinates the point “n” present in the i-th detection it will therefore only be necessary to position the flange of the automatic programmable positioner at the correct point in tool mode and acquire from the controller of the automatic programmable positioner the absolute coordinates of the said programmable automatic positioner. As will now be clear to the person skilled in the art, this results in further simplification of the calculations.

Both in the case where the equations indicated above by “(1)” are used and in the case where the tool function is used, the localization of the significant point of the surface is performed in practice by keeping substantially at a constant distance, perpendicular to the surface in the region of the significant point, the flange of the automatic programmable positioner on which the acquisition assembly will be suitably mounted.

In any case, once the spatial positions of the defects on the complex surface of the object have been obtained in the station 12, this data will be passed on to the following station for any defect evaluation and removal operations, as already described above.

At this point it is clear how the objects of the invention are achieved.

Owing to the plant according to the invention, the localization and removal, where necessary, of the defects is performed in a rapid, precise and efficient manner. Moreover, the complexity of the plant is reduced.

Obviously, the above description of the embodiments applying the innovative principles of the present invention is provided only by way of example of these innovative principles and must therefore not be regarded as limiting the scope of the rights claimed herein.

For example, a positioner different from that shown and described by way of example may be used and also the acquisition assembly may comprise an electromagnetic wave emission device and an optoelectronic device which are different.

Furthermore, the acquisition assembly may also be arranged in a position different from that of the flange centre of the positioner. In this case the necessary corrections to the spatial position of the assembly must be applied, as may be now easily imagined by the person skilled in the art.

1. A method for localizing defects on a complex surface of an object, the method comprising:
realizing an acquisition assembly with an electromagnetic wave emission device and an optoelectronic device for detecting electromagnetic waves reflected by the complex surface;
defining a scan path at a distance from the complex surface; and
during a defect search procedure:
moving the acquisition assembly along the scan path with an automatic positioner;
defining instants “i” during the moving of the acquisition assembly along the scan path at which the acquisition assembly is operated so as to acquire an image of the complex surface as a two-dimensional pixel matrix of the optoelectronic device;
storing in a control unit a plurality of consecutive two-dimensional pixel matrices obtained at the instants “i” along the scan path;
storing coordinates of the acquisition assembly along the scan path at the same instants “i” and associating the coordinates with respective two-dimensional matrices of the plurality of consecutive two-dimensional pixel matrices;
locating defects in the plurality of consecutive two-dimensional pixel matrices and identifying for each detect coordinates Xin, Yin of pixels representing a position of the defect in the corresponding two-dimensional matrix, with the index “i” representing an i-th matrix and the index “n” representing an n-th defect detected in the matrix; and
determining spatial coordinates (xn, yn, zn) on the complex surface of the n-th defect detected in the i-th matrix using a linear or linearizable transformation applied to the coordinates Xin, Yin of the defect detected in the i-th matrix and to the coordinates of the acquisition assembly which are associated with the i-th position.

2. The method of claim 1, wherein the image acquired at each instant “i” has a smaller dimension in a direction along the scan path than in a direction transverse to the scan path.

3. The method of claim 1, wherein the instants “i” are taken at time intervals, where L is a dimension of the image acquired at the instant “i” in a direction along the scan path and V is a movement speed of the acquisition assembly along the scan path.

4. The method of claim 1, wherein initial calibration is carried out before the defect search procedure, the initial calibration comprising:
highlighting on the complex surface points that define first segments on the complex surface;
moving the acquisition assembly along the scan path over the complex surface and acquiring, at predetermined instants, images of the complex surface with the first segments as a two-dimensional pixel matrix of the optoelectronic device;
detecting second segments in the two-dimensional matrix corresponding to the first segments on the complex surface; and
for each n-th second segment in each image acquired at the i-th instant, calculating coefficients Cni=D1/DL, where D1 is a length of the first segment and DL is a length of the corresponding second segment, and using these coefficients Cni as correction coefficients for the images at the same instants “i” during the defect search procedure.

5. The method of claim 4, wherein the coordinates (xn, yn, zn) of an n-th defect identified with coordinates Xin, Yin in the i-th matrix are calculated as:
xn=xri+cin*(a11*Xin+a12*Yin);
yn=yri+cin*(a21*Xin+a22+Yin); and
zn=zri+cin*(a31*Xin+a32*Yin);
where aij depend on trigonometric transformations and xri, yri and zri are spatial positions of the acquisition assembly detected at the same instants “i” during the defect search procedure.

6. The method of claim 1, wherein the automatic positioner is an anthropomorphic robot with a wrist provided with a flange on which the acquisition assembly is fixed, and wherein the absolute position of the acquisition assembly with respect to a defect on the complex surface is obtained using a “tool” function of the anthropomorphic robot, defining the reference axes of the “tool” function as “z tool”, “x tool”, and “y tool” axes, where:
the “z tool” axis is a direction of movement of the flange of the robot's wrist along a perpendicular to the flange itself, with a positive sign indicating a movement toward the complex surface;
the “x tool” axis is a direction of movement of the flange in a direction of travel along the scan path, with a positive sign indicating that the flange is proceeding along the scan path; and
the “y tool” axis is a direction orthogonal to the direction of travel along the scan path and orthogonal to the direction of movement of the flange along the perpendicular to the flange itself, with a positive sign corresponding to the left-hand-screw rule.

7. A plant adapted to operate according to the method of claim 1, the plant comprising:
a locating station for locating the defects on the complex surface of the object arriving at the locating station;
wherein the locating station comprises:
the automatic positioner; and
the acquisition assembly with the electromagnetic wave emission device and the optoelectronic device for detecting the electromagnetic waves reflected by the complex surface;
wherein the acquisition assembly is mounted on the automatic positioner so as to be movable along the scan path on the complex surface of the object under control of the control unit.

8. The plant of claim 7, further comprising:
detect inspection and/or repair stations.

9. The plant of claim 8, wherein there is an object transportation line between the locating station and the defect inspection and/or repair stations.

10. The plant of claim 7, wherein the object is a body of a motor vehicle.

11. A plant adapted to operate according to the method of claim 1, the plant comprising:
at least one locating station for locating the defects on the complex surface of the object arriving at the at least one locating station;
wherein the at least one locating station comprises:
the automatic positioner; and
the acquisition assembly with the electromagnetic wave emission device and the optoelectronic device for detecting the electromagnetic waves reflected by the complex surface;
wherein the acquisition assembly is mounted on the automatic positioner so as to the movable along the scan path on the complex surface of the object under control of the control unit.

12. The plant of claim 11, further comprising:
a detect inspection station downstream of the at least one locating station.

13. The plant of claim 12, wherein there is an object transportation line between the at least one locating station and the defect inspection station.

14. The plant of claim 11, further comprising:
a repair station downstream of the at least one locating station.

15. The plant of claim 14, wherein there is an object transportation line between the at least one locating station and the repair station.

16. The plant of claim 11, further comprising:
a defect inspection station and a repair station downstream of the at least one locating station.

17. The plant of claim 16, wherein there is an object transportation line between the at least one locating station and the defect inspection station.

18. The plant of claim 16, wherein there is an object transportation line between the at least one locating station and the repair station.

19. The plant of claim 16, wherein there is an object transportation line between the at least one locating station, the defect inspection station, and the repair station.

20. The plant of claim 19, wherein the object transportation line comprises a conveyor.
